(19) United States
(12) Patent Application Publication
(10) Pub. No.: US 2026/0204014 A1
(43) Pub. Date: Jul. 16, 2026

(54) POINT CLOUD PROCESSING DEVICE, POINT CLOUD PROCESSING METHOD, AND STORAGE MEDIUM

(71) Applicant: TOYOTA JIDOSHA KABUSHIKI KAISHA, Toyota-shi (JP)

(72) Inventors: Ryusuke UMEYAMA, Susono-shi (JP); Shoichi HAYASAKA, Atsugi-shi (JP); Shinya OHKAWA, Matsuyama-shi (JP)

(73) Assignee: TOYOTA JIDOSHA KABUSHIKI KAISHA, Toyota-shi (JP)

(21) Appl. No.: 19/416,556

(22) Filed: Dec. 11, 2025

(30) Foreign Application Priority Data
Jan. 16, 2025 (JP) 2025-006166

(51) Int. Cl. G06T 17/00; G01S 17/89; G01S 17/931

(52) U.S. Cl. CPC G06T 17/00; G01S 17/89; G01S 17/931

(57) ABSTRACT

The point cloud processing device includes: a generating unit that generates a point cloud holding region that is a region including a target object existing in front of the own vehicle detected by the millimeter-wave radar; and a determining unit that determines whether or not a point cloud indicating a peripheral state of the own vehicle generated by LiDAR that detects the peripheral state of the own vehicle is present in the point cloud holding region generated by the generating unit, and when determining that the point cloud indicating the peripheral state of the own vehicle is present in the point cloud holding region, the determining unit outputs a point cloud indicating the peripheral state of the own vehicle as a point cloud corresponding to the target object existing in front of the own vehicle detected by the millimeter-wave radar.

### CROSS-REFERENCE TO RELATED APPLICATION

This application claims priority to Japanese Patent Application No. 2025-006166 filed on January 16, 2025. The disclosure of the above-identified application, including the specification, drawings, and claims, is incorporated by reference herein in its entirety.

### BACKGROUND

### 1. TECHNICAL FIELD

The present disclosure relates to a point cloud processing device, a point cloud processing method, and a storage medium.

### 2. Description of Related Art

Japanese Unexamined Patent Application Publication No. 2023-42673 (JP 2023-42673 A) describes an automated driving mine vehicle that suppresses decrease in work efficiency when dust is generated in a work site. Also, in JP 2023-42673 A, there are cases in which transmittance of laser irradiated from a LiDAR (Light Detection And Ranging) device deteriorates and reflected waves cannot be obtained when dust is generated due to other vehicles traveling, and so forth. It is described therein that in this case, a non-detection region (region where LiDAR point cloud data cannot be obtained) will be generated. Further, in the technology described in JP 2023-42673 A, an alternative route over which the vehicle can travel, without passing through the non-detection region, is calculated. Description is made in JP 2023-42673 A that decrease in work efficiency due to dust generated at the work site can be suppressed, since a scheduled route is updated by the alternative route.

### SUMMARY

When dust is generated, not only are there cases in which the reflected waves cannot be obtained, as described in JP-A-2023-42673, but also cases in which the dust is detected as a point cloud. In the technology described in JP 2023-42673 A, when dust is detected as a point cloud, there is a concern that an own vehicle will be erroneously decelerated or the like, in order to avert collision with the point cloud.

Also, in an actual environment, in a case in which the entire surface of the road on which the own vehicle is traveling is covered with dust by the wind, dust stirred up by nearby vehicles traveling ahead of the own vehicle may be airborne for a long time. In this case, there are cases in which there is insufficient road width or other routes by which the own vehicle can bypass the region of dust, and in a technique in which the own vehicle circumvents the region of dust, there is concern that decrease in work efficiency cannot be suppressed.

Technology that enables the own vehicle to travel while averting nearby vehicles, obstructions, and so forth, which are collision risks, without circumventing dust or the like, which is no collision risk, is desired.

In view of the above, it is an object of the present disclosure to provide a point cloud processing device, a point cloud processing method, and a storage medium, capable of enabling travelling while averting nearby vehicles, obstructions, and so forth, without circumventing dust or the like, which is no collision risk. The nearby vehicles, the obstructions, and so forth, are nearby vehicles, obstructions, and so forth, which pose a risk of collision for the own vehicle.

(1) One aspect of the present disclosure is a point cloud processing device, including a generating unit for generating a point cloud holding region that is a region including a target, that is present forward of an own vehicle, and that is detected by a millimeter-wave radar, and

a determining unit for determining whether a point cloud indicating a peripheral state of the own vehicle, generated by a LiDAR device for detecting a peripheral state of the own vehicle, is present in the point cloud holding region generated by the generating unit, in which

when determining that a point cloud indicating a peripheral state of the own vehicle is present in the point cloud holding region, the determining unit outputs a point cloud indicating a peripheral state of the own vehicle, as a point cloud corresponding to the target present forward of the own vehicle detected by the millimeter-wave radar.

(2) In the point cloud processing device of (1), when determining that no point cloud indicating the peripheral state of the own vehicle is present in the point cloud holding region, the determining unit may discard the point cloud indicating the peripheral state of the own vehicle, as being a point cloud corresponding to any one of dust, rain, or fog, forward of the own vehicle.

(3) In the point cloud processing device of (2),

a point cloud indicating a peripheral state of the own vehicle, discarded by the determining unit, may not be used for automated driving control of the own vehicle, and

a point cloud indicating a peripheral state of the own vehicle, output by the determining unit, may be used for automated driving control of the own vehicle.

(4) An aspect of the present disclosure is a point cloud processing method including generating, by a point cloud processing device, a point cloud holding region that is a region including a target, that is present forward of an own vehicle, and that is detected by a millimeter-wave radar, and

determining, by the point cloud processing device, whether a point cloud indicating a peripheral state of the own vehicle, generated by a LiDAR device that detects the peripheral state of the own vehicle, is present in the point cloud holding region generated in the generating.

When in the determining, a point cloud indicating a peripheral state of the own vehicle is determined to be present in the point cloud holding region, a point cloud indicating a peripheral state of the own vehicle is output as a point cloud corresponding to the target that is present forward of the own vehicle detected by the millimeter-wave radar.

(5) An aspect of the present disclosure is a storage medium storing a program that causes a processor to execute

generating a point cloud holding region that is a region including a target, that is present forward of an own vehicle, and that is detected by a millimeter-wave radar, and

determining whether a point cloud indicating a peripheral state of the own vehicle, generated by a LiDAR device for detecting a peripheral state of the own vehicle, is present in the point cloud holding region generated in the generating.

When, in the determining, a point cloud indicating a peripheral state of the own vehicle is determined to be present in the point cloud holding region, a point cloud indicating a peripheral state of the own vehicle is output as a point cloud corresponding to the target that is present forward of the own vehicle detected by the millimeter-wave radar.

According to the present disclosure, the own vehicle can travel while averting nearby vehicles, obstructions, and so forth, which are collision risks, without circumventing dust or the like, which is no collision risk.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of the own vehicle 1 to which the point cloud processing device 16 according to the first embodiment is applied;

FIG. 2 is a diagram illustrating an example of a flow of data in the own vehicle 1 illustrated in FIG. 1;

FIG. 3 is a flowchart for describing an exemplary process executed by the processor 163 of the point cloud processing device 16 according to the first embodiment; and

FIG. 4 is a diagram for explaining a specific example of the processing illustrated in FIG. 3.

### DETAILED DESCRIPTION OF EMBODIMENTS

Hereinafter, an embodiment of a point cloud processing device, a point cloud processing method, and a program of the present disclosure will be described with reference to the drawings.

### First Embodiment

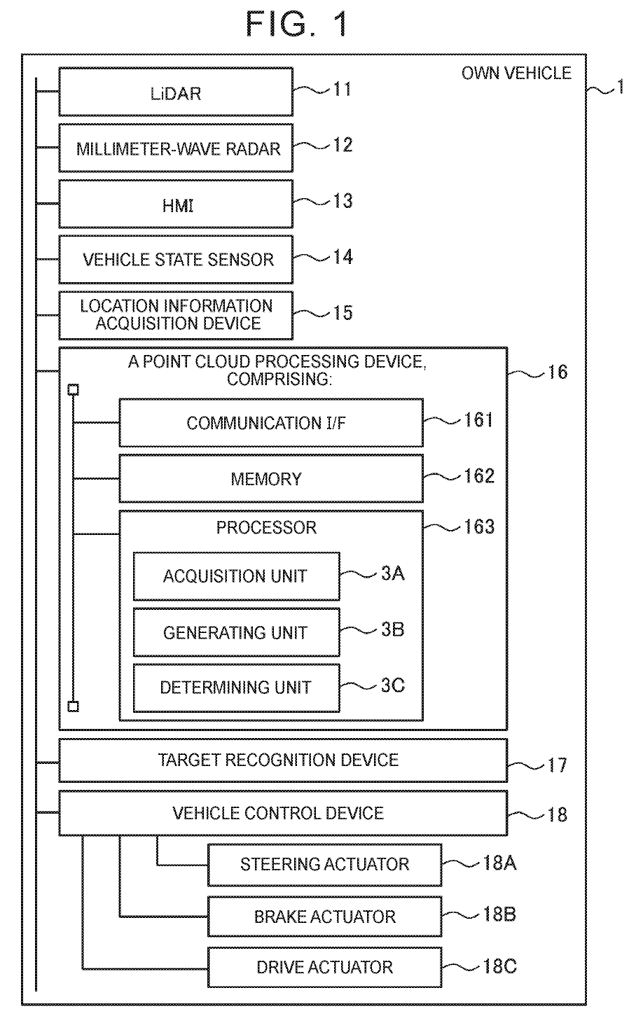

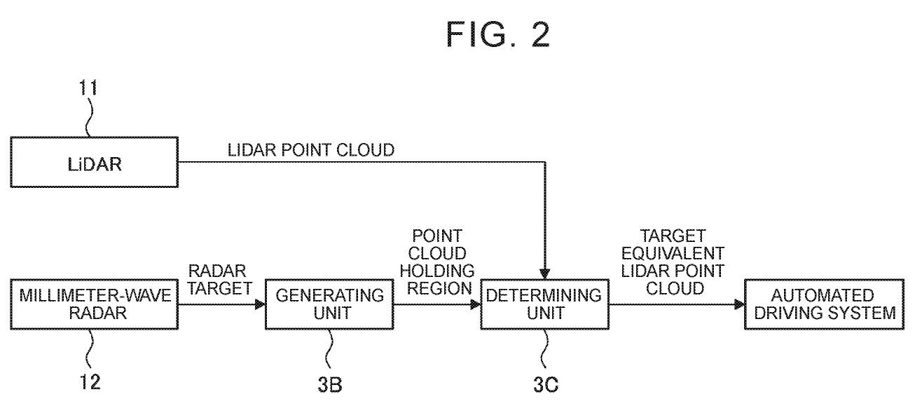

FIG. 1 is a diagram illustrating an example of the own vehicle 1 to which the point cloud processing device 16 according to the first embodiment is applied. FIG. 2 is a diagram illustrating an example of a flow of data in the own vehicle 1 illustrated in FIG. 1.

In the embodiments illustrated in FIGS. 1 and 2, the own vehicle 1 includes a LiDAR 11, a millimeter-wave radar 12, an HMI (Human Machine Interface) 13, a vehicle state sensor 14, a position information acquisition device 15, a point cloud processing device 16, a target recognition device 17, a vehicle control device 18, a steering actuator 18A, a braking actuator 18B, and a drive actuator 18C.

LiDAR 11 is disposed at a front portion of the own vehicle 1, for example, as illustrated in FIG. 4. LiDAR 11 detects a peripheral state (e.g., terrain, presence or absence of an object, etc.) of the own vehicle 1. In addition, LiDAR 11 generates a point cloud PD1 (see FIG. 4) from the point cloud PD3 indicating the peripheral state of the own vehicle 1, and transmits PD3data (LiDAR point cloud (see FIG. 2)) from the point cloud PD1 to the point cloud processing device 16.

In intensive studies, the present inventors have found that not only PD1,PD2 (see FIG. 4) but also the point cloud PD3 (see FIG. 4) are generated by LiDAR 11 while the own vehicle 1 is advancing on an unpaved road. In the point cloud PD1, PD2 corresponds to a target TG1 (see FIG. 4) (a surrounding vehicle PV (see FIG. 4)) and a target TG2 (see FIG. 4) (an obstacle BT (see FIG. 4)) existing in front of the own vehicle 1. The point cloud PD3 corresponds to a dust CD (see FIG. 4), rain, fog, or the like in front of the own vehicle 1. That is, the present inventors have found that LiDAR 11 may not only detect the surrounding vehicle PV as the peripheral state of the own vehicle 1, or detect the obstacle BT as the peripheral state of the own vehicle 1, but may also detect the dust CD, rain, fog, and the like as the peripheral state of the own vehicle 1. The surrounding vehicle PV is a vehicle in front of the own vehicle 1 in which the own vehicle 1 needs to circumvent a collision (that is, the steering actuator 18A and the braking actuator 18B need to be controlled). The obstacle BT is an obstacle in front of the own vehicle 1 where the own vehicle 1 needs to circumvent a collision. The dust CD, the rain, the fog, and the like are dust CD, rain, fog, and the like in front of the own vehicle 1 (that is, the steering actuator 18A and the braking actuator 18B do not need to be controlled) in which the own vehicle 1 does not need to circumvent a collision. Therefore, in the exemplary embodiments illustrated in FIGS. 1 and 2, measures to be described later are taken in order to distinguish between the point cloud PD1, PD2 and the point cloud PD3. In the point cloud PD1, PD2 corresponds to a target TG1 (surrounding vehicle PV) and a target TG2 (obstacle BT) in front of the own vehicle 1 where the own vehicle 1 needs to circumvent a collision. The point cloud PD3 corresponds to a dust CD, rain, fog, or the like in front of the own vehicle 1 where the own vehicle 1 does not need to circumvent a collision.

In the example illustrated in FIGS. 1 and 2, the millimeter-wave radar 12 is disposed at the front portion of the own vehicle 1 as in the example illustrated in FIG. 4, for example. The millimeter-wave radar 12 detects a target TG1, TG2 (see FIG. 4) existing in front of the own vehicle 1, and transmits information (sensor data) (Radar target (see FIG. 2)) related to the target TG1, TG2 to the point cloud processing device 16 and the target recognition device 17.

HMI 13 has a function of accepting various operations of the user of the own vehicle 1, and transmits a signal indicating the operation of the user of the own vehicle 1 to the vehicle control device 18. The operation of the user of the own vehicle 1 received by HMI 13 includes, for example, an operation of causing the vehicle control device 18 to execute the automated driving control of the own vehicle 1, an operation of switching the automated driving of the own vehicle 1 to the manual driving, and the like.

The vehicle state sensor 14 includes, for example, a vehicle speed sensor. The vehicle state sensor 14 transmits information (for example, vehicle speed and the like) indicating the state of the own vehicle 1 to the vehicle control device 18.

The position information acquisition device 15 acquires information indicating the position of the own vehicle 1. The position-information acquisition device 15 includes, for example, a GPS (Global Positioning System) device that measures the position of the own vehicle 1. The position information acquisition device 15 may perform a well-known self-position estimation process (localization) to increase the accuracy of information indicating the position of the own vehicle 1. The position information acquisition device 15 transmits information indicating the position of the own vehicle 1 to the vehicle control device 18.

The point cloud processing device 16 executes the processing of PD3 (see FIG. 4) from the point cloud PD1 generated by LiDAR 11, and transmits the result of the processing of PD3 (target equivalent LiDAR point cloud (see FIG. 2)) from the point cloud PD1 to the target recognition device 17.

The target recognition device 17 performs recognition of the target TG1, TG2 on the basis of the sensor data of the millimeter-wave radar 12 (information on the target TG1, TG2 (see FIG. 4) existing in front of the own vehicle 1 detected by the millimeter-wave radar 12) (specifically, time-series data) and the result of the processing of PD3 (see FIG. 4) from the point cloud PD1 executed by the point cloud processing device 16. The information on the target TG1,TG2includes target position information (information indicating the relative position of the target TG1, TG2 with respect to the own vehicle 1) and tracking information. The tracking information is information that can distinguish whether or not the target TG1, TG2 outputted from the millimeter-wave radar 12 in time series are the same. The target recognition device 17 transmits the recognition result of the target TG1, TG2 to the vehicle control device 18.

The vehicle control device 18 is constituted by, for example, a vehicle control ECU (Electronic Control Unit). The vehicle control device 18 controls the steering actuator 18A, the braking actuator 18B, and the drive actuator 18C based on the information. The information (signal) is information transmitted from HMI 13, the vehicle-state sensor 14, the position information acquisition device 15, and the target recognition device 17. The vehicle control device 18 has a function of executing automated driving control of the own vehicle 1.

When the autonomous driving control of the own vehicle 1 is executed, an autonomous driving system (see FIG. 2) is configured by the target recognition device 17 and the vehicle control device 18.

The point cloud processing device 16 is constituted by a microcomputer including a communication interface (I/F) 161, a memory 162, and a processor 163.

The communication interface 161 includes interface circuitry for connecting the point cloud processing device 16 to LiDAR 11, the millimeter-wave radar 12, HMI 13, the vehicle state sensor 14, the position information acquisition device 15, the target recognition device 17, and the vehicle control device 18.

The memory 162 stores programs and various types of data used in processing executed by the processor 163.

The processor 163 has a function as an acquiring unit 3A, a function as a generating unit 3B, and a function as a determining unit 3C.

The acquiring unit 3A acquires, from LiDAR 11, data (LiDAR point cloud (see FIG. 2)) of PD3 (see FIG. 4) from the point cloud PD1 indicating the peripheral state of the own vehicle 1 generated by LiDAR 11. Further, the acquiring unit 3A acquires, from the millimeter-wave radar 12, information about the target TG1, TG2 (see FIG. 4) existing in front of the own vehicle 1 detected by the millimeter-wave radar 12.

The generating unit 3B generates a point cloud holding region PA1, PA2 (see FIG. 4), which is an area including the target TG1, TG2, based on the information about the target TG1, TG2 (see FIG. 4) acquired by the acquiring unit 3A. In the example illustrated in FIG. 4, which will be described later, a point cloud holding region having a fixed size and a fixed shape designated as self-washing for all targets is generated on the basis of the size of the maximum detection target to be assumed. That is, in the embodiment illustrated in FIG. 4, the size and the shape of the point cloud holding region PA1, PA2 are the same. In another example, the likelihood for each detection target (a truck, a vehicle, a rock, a person, an animal, or the like) may be calculated based on the information such as the reflected power and the speed detected by the millimeter-wave radar 12, and a point cloud holding region corresponding to the size and shape of the target having the highest likelihood may be generated.

In the embodiments illustrated in FIGS. 1 and 2, the determining unit 3C determines whether or not a PD3 (see FIG. 4) is present in the point cloud holding region PA1, PA2 (see FIG. 4) from the point cloud PD1 indicating the peripheral state of the own vehicle 1 acquired by the acquiring unit 3A. The point cloud holding region PA1, PA2 is generated by the generating unit 3B.

In some cases, it is determined that the point cloud PD1, PD2 indicating the peripheral state of the own vehicle 1 exists in the point cloud holding region PA1,PA2. The determining unit 3C outputs the point cloud PD1,PD2 indicating the peripheral state of the own vehicle 1 to the target recognition device 17 as a point cloud (target equivalent LiDAR point cloud (see FIG. 2)). The point cloud corresponds to a target TG1, TG2 (see FIG. 4) existing in front of the own vehicle 1 detected by the millimeter-wave radar 12. The point cloud PD1, PD2 indicating the peripheral state of the own vehicle 1 outputted to the target recognition device 17 by the determining unit 3C is used by the target recognition device 17 and the vehicle control device 18 for autonomous driving control of the own vehicle 1. Specifically, the vehicle control device 18 controls the steering actuator 18A, the braking actuator 18B, and the drive actuator 18C so that the target TG1, TG2 corresponding to the point cloudPD1, PD2 and the own vehicle 1 are suppressed from colliding with each other.

On the other hand, the determining unit 3C may determine that the point cloud PD3 (see FIG. 4) indicating the peripheral state of the own vehicle 1 does not exist in the point cloud holding region PA1, PA2 (see FIG. 4). In this case, the determining unit 3C discards the point cloud PD3 indicating the peripheral state of the own vehicle 1 as a point cloud corresponding to the dust CD (see FIG. 4), rain, fog, and the like in front of the own vehicle 1, and does not output the point cloud to the target recognition device 17. That is, the point cloud indicating the peripheral state of the own vehicle 1 discarded by the determining unit 3C is not used for the autonomous driving control of the own vehicle 1. That is, the control of the steering actuator 18A and the braking actuator 18B for circumventing dust CD (see FIG. 4), rain, fog, and the like in front of the own vehicle 1 without the risk of colliding with the own vehicle 1 is not executed by the vehicle control device 18.

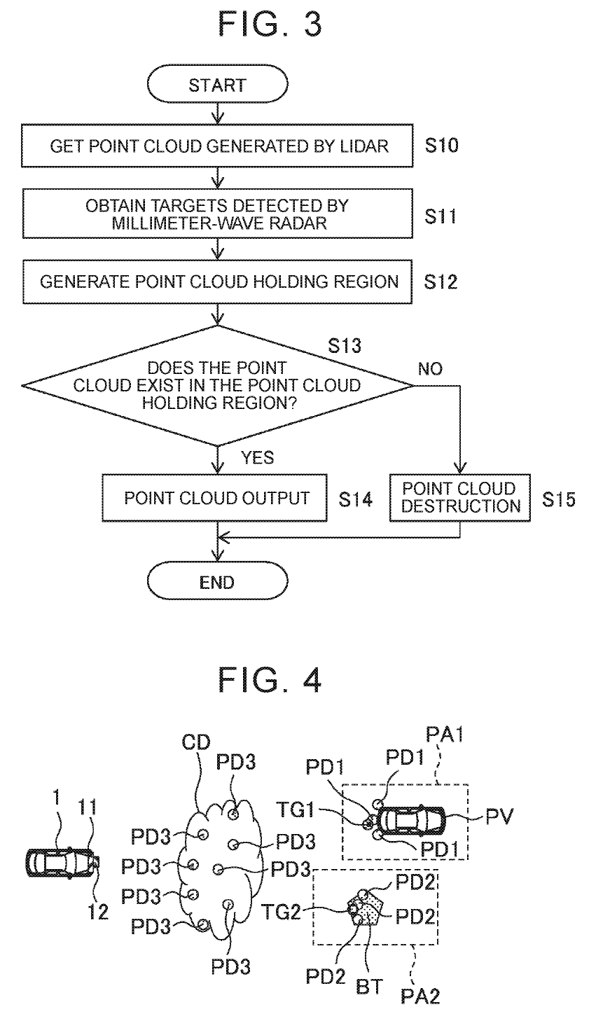

FIG. 3 is a flowchart for describing an example of processing executed by the processor 163 of the point cloud processing device 16 according to the first embodiment.

The processing illustrated in FIG. 3 is executed, for example, while the own vehicle 1 is traveling (specifically, while moving forward).

In the embodiment illustrated in FIG. 3, in S10, the acquiring unit 3A acquires PD3 (see FIG. 4) from LiDAR 11 from the point cloud PD1 indicating the peripheral state of the own vehicle 1 generated by LiDAR 11.

In S11, the acquiring unit 3A acquires, from the millimeter-wave radar 12, information about the target TG1, TG2 (see FIG. 4) existing in front of the own vehicle 1 detected by the millimeter-wave radar 12.

In S12, the generating unit 3B generates a point cloud holding region PA1, PA2 (see FIG. 4), which is an area including the target TG1, TG2, based on the information about the target TG1, TG2 acquired in S11.

In S13, the determining unit 3C determines whether or not a PD3 (see FIG. 4) is present in the point cloud holding region PA1, PA2 (see FIG. 4) generated in S12 from the point cloud PD1 indicating the peripheral state of the own vehicle 1 acquired in S10. When YES, proceed to S14; when NO, proceed to S15.

In S14, the determining unit 3C outputs the point cloud PD1, PD2 indicating the peripheral state of the own vehicle 1 to the target recognition device 17 as a point cloud corresponding to the target TG1, TG2 (see FIG. 4) existing in front of the own vehicle 1 detected by the millimeter-wave radar 12.

In S15, the determining unit 3C discards the point cloud PD3 indicating the peripheral state of the own vehicle 1 as a point cloud corresponding to the dust CD (see FIG. 4), rain, fog, and the like in front of the own vehicle 1, and does not output the point cloud to the target recognition device 17.

FIG. 4 is a diagram for explaining a specific example of the processing illustrated in FIG. 3.

As illustrated in FIG. 4, the dust CD, the surrounding vehicle PV, and the obstacle BT may exist in front of the own vehicle 1. In this case, in S10 of FIG. 3, the acquiring unit 3A acquires, from LiDAR 11, point cloud PD1 indicating the peripheral state of the own vehicle 1 generated by LiDAR 11 (point cloud corresponding to the surrounding vehicle PV), point cloud PD2 (point cloud corresponding to the obstacle BT), and point cloud PD3 (point cloud corresponding to the dust CD).

In S11 of FIG. 3, the acquiring unit 3A acquires, from the millimeter-wave radar 12, information regarding a target TG1 (a target corresponding to a surrounding vehicle PV) and a target TG2 (a target corresponding to an obstacle BT) existing in front of the own vehicle 1 detected by the millimeter-wave radar 12.

In S12 of FIG. 3, the generating unit 3B generates a point cloud holding region PA2 including the point cloud holding region PA1 including the target TG1 and the target TG2 based on the information on the target TG1, TG2 acquired in S11.

In S13 of FIG. 3, the determining unit 3C determines that the point cloud PD3 indicating the peripheral state of the own vehicle 1 acquired in S10 does not exist in the point cloud holding region PA1, PA2 generated in S12. In S15 of FIG. 3, the determining unit 3C discards the point cloud PD3 indicating the peripheral state of the own vehicle 1 as a point cloud corresponding to the dust CD, rain, fog, and the like in front of the own vehicle 1, and does not output the point cloud to the target recognition device 17. Consequently, the own vehicle 1 passes through the sand and dust CD without executing the control of the steering actuator 18A and the braking actuator 18B to circumvent the sand and dust CD.

In S13 of FIG. 3 executed after the own vehicle 1 passes the dust CD, the determining unit 3C determines that the point cloud PD1 indicating the peripheral state of the own vehicle 1 acquired in S10 exists in the point cloud holding region PA1 generated in S12. Further, the determining unit 3C determines that the point cloud PD2 indicating the peripheral state of the own vehicle 1 acquired in S10 exists in the point cloud holding region PA2 generated in S12. In S14 of FIG. 3, the determining unit 3C outputs the point cloud PD1, PD2 indicating the peripheral state of the own vehicle 1 to the target recognition device 17 as a point cloud corresponding to the target TG1, TG2 existing in front of the own vehicle 1 detected by the millimeter-wave radar 12. Consequently, the vehicle control device 18 controls the steering actuator 18A, the braking actuator 18B, and the drive actuator 18C that cause the own vehicle 1 to travel while circumventing a collision between the target TG1, TG2 and the own vehicle 1.

As described above, in the examples illustrated in FIGS. 1 to 4, it is possible to suppress the possibility that the own vehicle 1 will erroneously decelerate as CD of dust in the air is detected as the point cloud PD3 by using LiDAR 11 in an environment in which the dust CD is present in the automated driving system.

In the exemplary embodiments illustrated in FIGS. 1 to 4, a property in which the dust CD is not detected by the millimeter-wave radar 12 (millimeter-wave is transmitted through the sand dust CD) is used, and it is considered that there is no target at a position where the target is not detected by the millimeter-wave radar 12, and using this idea, the point cloud LiDAR 11 is generated from the point cloud PD1 generated by PD3 to remove the point cloud PD3 corresponding to the sand dust.

Consequently, the control of the steering actuator 18A, the braking actuator 18B, and the drive actuator 18C is executed for the surrounding vehicle PV and the obstacle BT that need to circumvent collision with the own vehicle 1, but the control of the steering actuator 18A and the braking actuator 18B is not executed for the dust CD that does not need to circumvent collision with the own vehicle 1. Consequently, the own vehicle 1 can pass through the sand and dust CD without circumventing the sand and dust CD.

Specifically, in the examples illustrated in FIGS. 1 to 4, when LiDAR 11 is not used, a part of the lasers of LiDAR 11 passes through the sand and dust CD and reaches the surrounding vehicle PV and the obstacle BT, the surrounding vehicle PV and the obstacle BT that cannot be recognized can be recognized.

### Second Embodiment

The own vehicle 1 to which the point cloud processing device 16 of the second embodiment is applied is configured in the same manner as the own vehicle 1 to which the point cloud processing device 16 of the first embodiment described above is applied, except for the points described later.

As described above, in the own vehicle 1 (autonomous vehicle) to which the point cloud processing device 16 of the first embodiment is applied, the vehicle control device 18 executes control in order to circumvent a collision between the own vehicle 1 and the target TG1, TG2. The control is a control for actuating the steering actuator 18A and/or the braking actuator 18B based on the point cloud PD1, PD2 outputted by the determining unit 3C.

On the other hand, in the own vehicle 1 to which the point cloud processing device 16 of the second embodiment is applied, the vehicle control device 18 causes HMI 13 to output an alert based on the point cloud PD1, PD2 output by the determining unit 3C. The warning is a warning indicating that an operation for circumventing a collision between the own vehicle 1 and the target TG1, TG2 is required.

As described above, embodiments of the point cloud processing device, the point cloud processing method, and the program of the present disclosure have been described with reference to the drawings. The point cloud processing device, the point cloud processing method, and the program of the present disclosure are not limited to the above-described embodiments, and can be appropriately modified without departing from the spirit of the present disclosure. The configuration of each example of the above-described embodiment may be combined as appropriate. In each example of the above-described embodiment, the processing performed in the point cloud processing device 16 has been described as software processing performed by executing a program. The processing performed by the point cloud processing device 16 may be a processing performed by hardware. Alternatively, the processing performed by the point cloud processing device 16 may be a combination of both software and hardware. Further, a program (a program for realizing the function of the processor 163 of the point cloud processing device 16) stored in the memory 162 of the point cloud processing device 16 may be provided and distributed by being recorded in a computer-readable storage medium such as a semiconductor memory, a magnetic recording medium, an optical recording medium, or the like. The program is stored in a storage medium.

What is claimed is:

1. A point cloud processing device, comprising:
a generating unit for generating a point cloud holding region that is a region including a target, that is present forward of an own vehicle, and that is detected by a millimeter-wave radar; and
a determining unit for determining whether a point cloud indicating a peripheral state of the own vehicle, generated by a LiDAR device for detecting a peripheral state of the own vehicle, is present in the point cloud holding region generated by the generating unit, wherein,
when determining that a point cloud indicating a peripheral state of the own vehicle is present in the point cloud holding region, the determining unit outputs a point cloud indicating a peripheral state of the own vehicle, as a point cloud corresponding to the target present forward of the own vehicle detected by the millimeter-wave radar.

2. The point cloud processing device according to claim 1, wherein, when determining that no point cloud indicating the peripheral state of the own vehicle is present in the point cloud holding region, the determining unit discards the point cloud indicating the peripheral state of the own vehicle, as being a point cloud corresponding to any one of dust, rain, or fog, forward of the own vehicle.

3. The point cloud processing device according to claim 2, wherein
a point cloud indicating a peripheral state of the own vehicle, discarded by the determining unit, is not used for automated driving control of the own vehicle, and
a point cloud indicating a peripheral state of the own vehicle, output by the determining unit, is used for automated driving control of the own vehicle.

4. A point cloud processing method, comprising:
generating, a point cloud processing device, a point cloud holding region that is a region including a target, that is present forward of an own vehicle, and that is detected by a millimeter-wave radar; and
determining, the point cloud processing device, whether a point cloud indicating a peripheral state of the own vehicle, generated by a LiDAR device that detects the peripheral state of the own vehicle, is present in the point cloud holding region generated in the generating, wherein,
when, in the determining, a point cloud indicating a peripheral state of the own vehicle is determined to be present in the point cloud holding region, a point cloud indicating a peripheral state of the own vehicle is output as a point cloud corresponding to the target that is present forward of the own vehicle detected by the millimeter-wave radar.

5. A non-transitory storage medium storing a program that causes a processor to execute
generating a point cloud holding region that is a region including a target, that is present forward of an own vehicle, and that is detected by a millimeter-wave radar; and
determining whether a point cloud indicating a peripheral state of the own vehicle, generated by a LiDAR device for detecting a peripheral state of the own vehicle, is present in the point cloud holding region generated in the generating, wherein,
when, in the determining, a point cloud indicating a peripheral state of the own vehicle is determined to be present in the point cloud holding region, a point cloud indicating a peripheral state of the own vehicle is output as a point cloud corresponding to the target that is present forward of the own vehicle detected by the millimeter-wave radar.
